(19) United States
(12) Patent Application Publication
(10) Pub. No.: US 2025/0158479 A1
(43) Pub. Date: May 15, 2025

(54) ELECTRIC MOTOR, IN PARTICULAR RADIATOR FAN MOTOR

(71) Applicant: Brose Fahrzeugteile SE & Co. Kommanditgesellschaft, Würzburg, Würzburg (DE)

(72) Inventors: Christian WAGENBRENNER, Würzburg (DE); Felix HESS, Würzburg (DE)

(21) Appl. No.: 19/021,620

(22) Filed: Jan. 15, 2025

Related U.S. Application Data
(63) Continuation of application No. PCT/EP2023/069487, filed on Jul. 13, 2023.

(30) Foreign Application Priority Data
Jul. 15, 2022 (DE) 10 2022 207 250.2

(51) Int. Cl. H02K 5/22; H02K 1/18; H02K 3/30; H02K 5/10

(52) U.S. Cl. CPC H02K 5/225; H02K 1/187; H02K 3/30; H02K 5/10; H02K 2203/09

(57) ABSTRACT

An electric motor includes a motor carrier and a stator secured to the motor carrier, as well as a rotor surrounding the stator. A coil or winding insulation is provided at least on the side of the stator facing away from the motor carrier. Contact pins are disposed in a receiving or mounting space of the stator, for contacting the stator winding thereof via connection contacts, and are guided into a carrier-side electronics compartment. The coil or winding insulation has an annular body on which functional elements are formed for holding, positioning and/or centering the contact pins and/or the connection contacts.

### CROSS-REFERENCE TO RELATED APPLICATION

This application is a continuation, under 35 U.S.C. § 120, of copending International Patent Application PCT/EP2023/069487, filed Jul. 13, 2023, which designated the United States; this application also claims the priority, under 35 U.S.C. § 119, of German Patent Application DE 10 2022 207 250.2, filed Jul. 15, 2022; the prior applications are herewith incorporated by reference in their entirety.

### FIELD AND BACKGROUND OF THE INVENTION

The invention relates to an electric motor, in particular a brushless external rotor motor, preferably a radiator fan motor of a motor vehicle.

An electric motor of that type usually includes a rotor that is rotatably mounted in relation to a fixed stator. In a brushless electric motor, the stator is equipped with a stator or rotating field winding, which generates a rotating magnetic field by applying an alternating current to it. The rotor is usually fitted with permanent magnets, which generate a rotor magnetic field that interacts with the rotating field of the stator.

In a brushless electric motor, the alternating current intended to supply the stator winding is usually generated by a converter (inverter). In smaller electric motors, the converter and the associated control electronics are often housed in an electronics compartment that is integrated into the electric motor or its motor housing. The control electronics must be protected from moisture, which is why such electric motors, for example those used as radiator fan motors in motor vehicles, place comparatively high demands on the tightness of the electronics compartment. In addition, the stator winding should be reliably electrically insulated from the stator main body, which is often constructed as a laminated core formed of stacked laminations.

A brushless electric motor known from European Patent EP 2 852 035 B1, corresponding to U.S. Pat. Nos. 10,734,859 B2 and 10,734,860 B2, and configured as an internal rotor (motor), in particular a radiator fan motor, includes a rotor mounted rotatably relative to a stator and a motor carrier which contains an electronics compartment which is sealed or can be sealed with an electronics compartment lid to accommodate converter electronics. The stator with its radially inwardly directed stator teeth is encapsulated with a plastics sheath, onto which caulking studs are molded, which engage through fixing openings provided on the motor carrier and are hot caulked and deformed, for example, in the course of joining with the motor carrier manufactured as a cast part.

The sealing concept of the known electric motor includes sealing elements that allow the winding or connection ends of the stator-side rotating field winding formed from coils, which serve as phase connections, to pass through the electronics compartment in a sealed manner. Sealing elements made of a two-component plastic are provided for that purpose and include a hard and a comparatively soft sealing component as a one-piece component. In the assembled state, the sealing elements with their comparatively soft sealing component sit in through-openings that are made in the motor carrier in the region of the electronics compartment base. The comparatively hard support components of the sealing elements protrude from the support side of the motor carrier facing the stator and are seated axially above the stator-side plastics sheath in receiving pockets located therein. For reliable sealing of the winding ends at their exit points from the soft sealing component, sealing sleeves are formed onto these, which enclose the respective winding end in a sealing manner.

### SUMMARY OF THE INVENTION

It is accordingly an object of the invention to provide an electric motor, in particular a radiator fan motor, which overcomes the hereinafore-mentioned disadvantages of the heretofore-known motors of this general type and which addresses the problem of specifying an electric motor in an external rotor motor configuration, in which reliable positioning, centering, fixing and/or contacting of contact elements serving as phase connections is achieved.

With the foregoing and other objects in view there is provided, in accordance with the invention, a brushless electric motor provided and set up in particular for a radiator fan motor of a motor vehicle, having a plate-like or plate-shaped motor carrier (a motor carrier plate) with an electronics compartment for accommodating electronics (inverter electronics) and a stator and a rotor circulating around it. Suitably, the rotor has a pot-shaped rotor housing with permanent magnets disposed on the inside of the ring or housing wall. The rotor is mounted so as to be rotatable about a motor or rotation axis, which is preferably a rigid rotation axis, for example a rigid pivot bolt, fixed in the motor carrier, for example cast into it.

The stator of the electric motor, which is embodied as an external rotor motor, is disposed on the support side of the motor carrier opposite the electronics compartment. The stator has a stator main body, which is preferably configured as a laminated core formed of stacked stator plates or laminations. The stator or its stator main body has a preferably annular main body section and stator teeth disposed on the outside of the ring and directed radially outwards, on which coils of a stator winding (rotating field winding) are disposed. In the embodiment of the stator main body formed of laminations, these are substantially formed from a laminated ring with star-shaped teeth aligned on the outer circumference.

The annular main body part of the stator main body forms a receiving or mounting space in which axially oriented contact pins that make contact or can be contacted with the stator winding via connection contacts are disposed and which are guided into the electronics compartment via through-openings in the motor carrier. Advantageously, the contact pins extend over the entire axial length or height of the receiving or mounting space, which is formed in particular inside the stator main body and is enclosed by its main body part.

Coil or winding insulation is disposed on the stator main body on the side of the stator facing away from the motor carrier or on the side facing away from the motor carrier and on the side of the stator facing the motor carrier. The coil or winding insulation disposed on the side of the stator facing away from the motor carrier on the stator main body is also referred to below as the upper coil or winding insulation. The coil or winding insulation disposed on the side of the stator facing the motor carrier on the stator main body is also referred to below as the lower coil or winding insulation.

The upper coil or winding insulation disposed on the side of the stator facing away from the motor carrier on its stator main body has a ring body and radially outwardly directed tooth caps molded onto it on the (outer) circumferential side, which at least partially cover the stator teeth.

In an advantageous embodiment, the tooth caps of the upper coil or winding insulation have a cover cap portion extending in the plane of the ring body as well as side cap portions formed thereon, which extend radially and are oriented axially. In other words, the side cap portions are oriented in the radial direction and extend at least partially or in portions in the axial direction along the side surfaces of the stator teeth. Conveniently, the ring body has axially raised annular walls, preferably in the region of its inner radius.

Functional elements for holding, positioning and/or centering the contact pins or the connection contacts are formed on the inside of the ring body (in the region of its inner radius). Suitably, the functional elements provided for holding and/or positioning the contact pins are fork-shaped with two radial support pins or support elements, between which the respective contact pin is disposed or against which it is supported or rests. Preferably, the functional elements for holding and/or positioning the contact pins are molded onto the annular walls of the ring body of the upper coil or winding insulation.

Advantageous variants, embodiments and developments are the subject of the dependent claims.

The axially raised annular walls of the ring body, i.e., those extending in the axial direction, suitably fulfill a dual function. On the one hand, the annular walls are provided with (axial) plug-in openings, which serve as functional elements for the connection contacts for contacting the winding loops or winding ends of the stator winding, in particular its coils. On the other hand, the functional elements for holding and/or positioning the contact pins are molded onto the annular walls of the ring body of the upper coil or winding insulation in the form of radial support pins or support elements. The connection contacts have joining elements, in particular pins, which correspond to the functional elements of the upper coil or winding insulation, preferably to produce a plug-in connection of the connection contacts with the annular wall or with the upper coil or winding insulation.

According to an expedient development, the contact pins are guided into the electronics compartment via sealing elements in the through-openings of the motor carrier. Suitably, the stator main body has radial lugs that are aligned with the through-openings of the motor carrier and through which the associated contact pin passes. In particular, it is intended that the lower coil or winding insulation (disposed on the side of the stator facing the motor carrier on its stator main body) has a number of axially raised insulating pins corresponding to the number of contact pins, which insulating pins protrude into the receiving or mounting space of the stator main body and are penetrated by the respective contact pin. For example, the stator main body has radial or fastening lugs with through-openings for fastening elements projecting into the receiving or mounting space for fastening the stator to the mounting carrier.

Other features which are considered as characteristic for the invention are set forth in the appended claims.

Although the invention is illustrated and described herein as embodied in an electric motor, in particular a radiator fan motor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, exploded, perspective view of a brushless electric motor in an external rotor configuration, in particular as a radiator fan drive for a motor vehicle, with a rotor and with a stator having a stator winding (rotating field winding) and with a motor carrier with an electronics compartment for motor electronics (inverter electronics) which can be closed by an electronics compartment lid;

FIG. 2 is a cross-sectional view of an electric motor as shown in FIG. 1;

FIG. 3 is a top-plan view of the electric motor without a rotor housing, with (upper) coil insulation;

FIG. 4 is a perspective view showing a detail of the stator of the electric motor with upper coil insulation, looking towards the contact pins in their arrangement in fork-shaped positioning or holding elements of the (upper) coil insulation;

FIG. 5 is a perspective, top-plan view showing the (upper) coil insulation; and

FIG. 6 is a perspective bottom or rear-plan view showing the (upper) coil insulation.

### DETAILED DESCRIPTION OF THE INVENTION

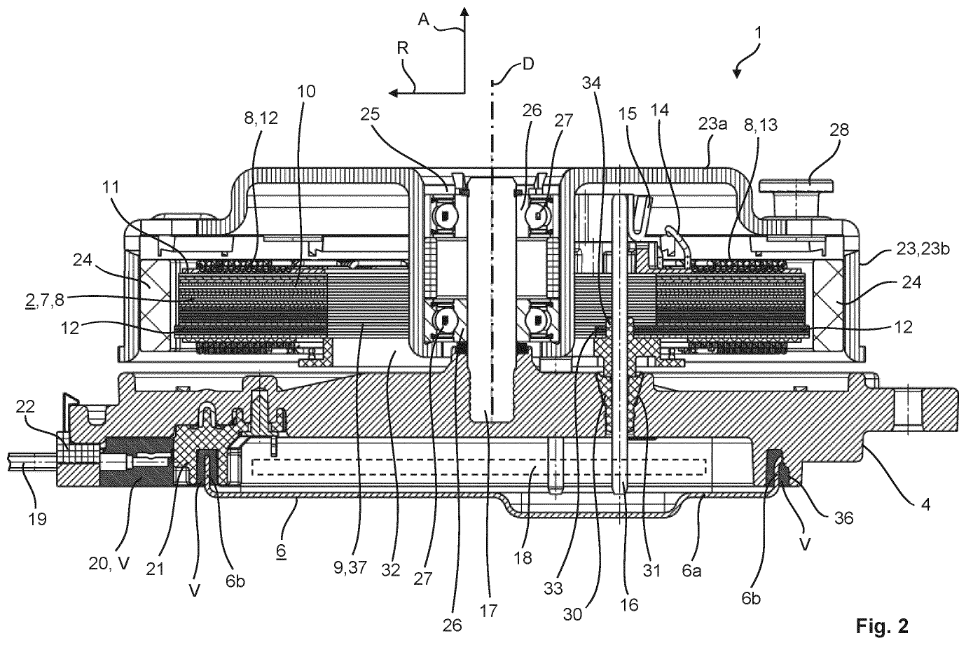

Referring now to the figures of the drawings in detail, it is seen that corresponding parts and sizes are marked with the same reference signs in all figures. Specifications such as axial and radial refer to a motor axis (rotation axis) D indicated in FIG. 2 and refer to the axial and radial directions A and R, respectively, shown in FIG. 2.

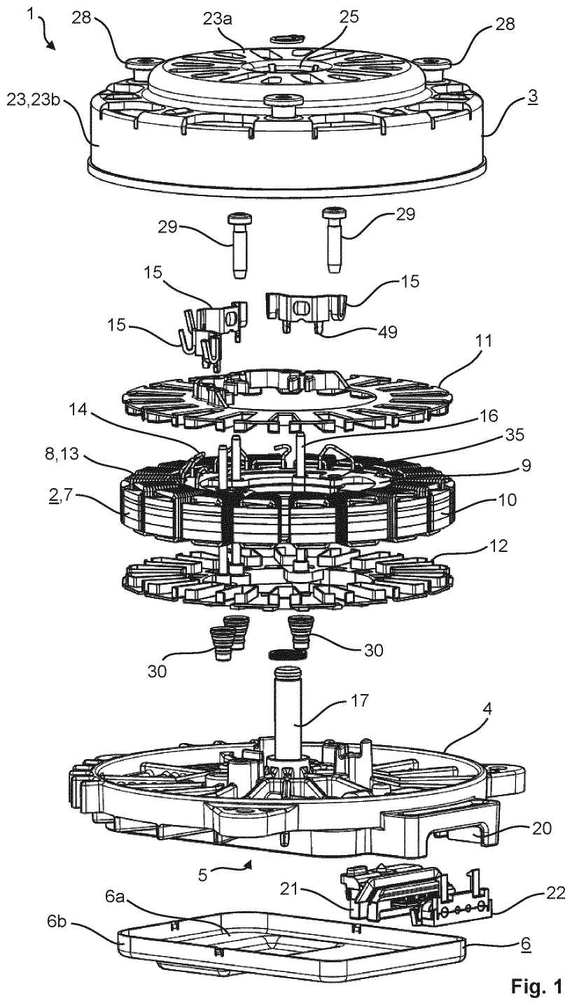

FIGS. 1 and 2 show an exploded view and a sectional view of an electric motor 1 configured as an external rotor, which is preferably intended and set up as a drive for a radiator fan of a motor vehicle. The electric motor 1, which is in particular three-phase (having three phases (U, V, W)), substantially has a stator 2 and a rotor 3 circulating around it as well as a (plate-like or plate-shaped) motor carrier 4, also referred to below as a support plate, with an electronics compartment 5, which can be closed with an electronics compartment lid 6. The motor carrier 4 is preferably a die-cast aluminum part. The electronics compartment lid 6, preferably made of aluminum or stainless steel, has a lid base 6a and a lid wall 6b molded thereon.

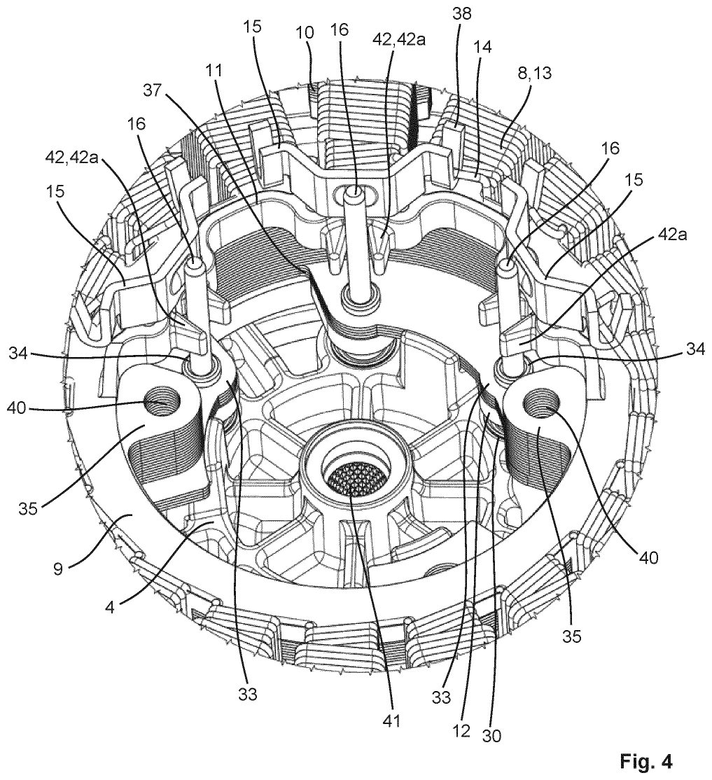

The stator 2 has a stator main body 7 and a stator or rotating field winding 8. The stator main body 7 is preferably formed from a number of laminations 37 (FIGS. 2 and 4) stacked to form a laminated core. The stator 2 or its stator main body 7 has an annular main body part 9 and radially outwardly directed stator teeth 10 molded onto the outer side.

At least one coil insulation 11 is provided, which is disposed on the side of the stator 2 facing away from the motor carrier 4 on its stator main body 7. In the exemplary embodiment, on both stator sides of the stator main body 7 or the laminated core there is provided in each case a coil or winding insulation 11, 12, which are also referred to below as the upper coil insulation 11 facing away from the motor carrier 4 and the lower coil insulation 12 facing the motor carrier 4. The coil insulations 11, 12, which are preferably made of a plastic, for example manufactured as an injection-molded part, cover the stator main body 7 and in particular the stator teeth 10, in each case at or on one stator side. Preferably, the coil insulations 11, 12 each partially overlap the stator main body 7 or its stator teeth 10. The stator main body 7 of the stator 2 covered by the coil insulations 11, 12 is provided with the stator winding 8, which is preferably formed of interconnected coils 13, which in turn are wound onto the individual stator teeth 10 with the coil insulations 11, 12 interposed.

In FIG. 1, the two coil insulations 11, 12 are shown separately to make them recognizable, while FIG. 2 shows the actual assembly situation of the stator main body 7 provided with the coil insulations 11, 12. This is wound with the coils 13 of the stator winding 8 with the coil insulations 11, 12 interposed. Winding loops or winding ends 14 of the stator winding 8 are electrically conductively connected to busbar-like connection contacts 15, which connection contacts 15 are contacted, for example welded, with contact pins 16. The contact pins 16 are or serve as phase contacts of the stator 2 or its stator winding 8.

The motor carrier 4 has, on its support side assigned to the stator 2 and the rotor 3, a rigid rotation axis in the form of an axle bolt 17, which is cast into the motor carrier 4 or disposed in a bolt receptacle of the motor carrier 4 in a rotationally fixed manner, for example cast or compressed therein. The axle bolt 17 effectively forms the rotation axis or motor axis D of the electric motor 1 or rotor 3.

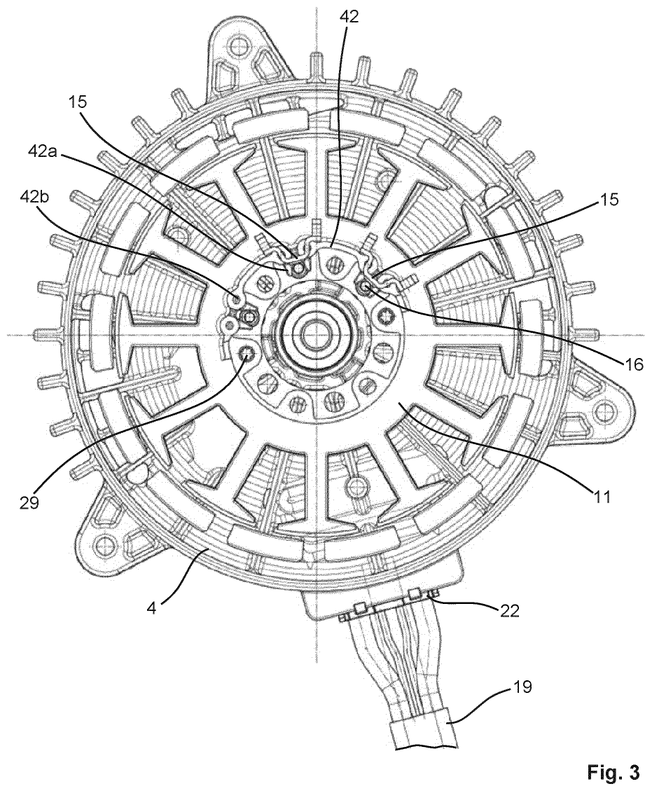

On the carrier side opposite the stator 2 and the rotor 3, the electronics compartment 5 for the motor electronics 18 is provided in the motor carrier 4. The electronics compartment 5 opens at one end into a plug compartment 20, into which two plug parts 21, 22 (an inner plug part 21 and an outer plug part 22) provided for contacting with a connection cable 19 (FIG. 3) can be inserted in the exemplary embodiment. When the electric motor 1 is installed, the electronics compartment 5 is sealed, in particular in a moisture-proof manner, with the electronics compartment lid 6.

The rotor 3 has a pot-like rotor housing 23 with a housing base 23a and a housing wall (annular wall, housing wall) 23b oriented in axial direction A. Permanent magnets 24 are disposed on the inside of this wall. The rotor housing 23 has a central, preferably hollow-cylindrical housing portion deep-drawn in the housing base 23a as a bearing housing 25 for two roller or ball bearings 26, which are axially spaced in relation to the rotation axis D in the exemplary embodiment. Their unspecified outer rings are held in the deep-drawn bearing housing 25 so that they cannot rotate, and their unspecified inner rings are firmly connected to the axle bolt 17, wherein bearing balls (bearing elements) 27 are disposed between the outer and inner rings (FIG. 2).

Mounting elements 28, for example screws, correspond to the rotor housing 23 for fastening a fan wheel, not shown, of the radiator fan to the rotor 3. The other fastening elements 29, shown, for example screws or bolts, are used to fasten the stator 1 to the motor carrier 4.

Collar-like or plug-like sealing elements 30 for the contact pins 16 can also be seen in order to seal them off from the motor carrier 4. For this purpose, the motor carrier 4 has corresponding through-openings 31 (FIG. 2), in which the sealing elements 30, through which the contact pins 16 pass, fit in a sealing manner. The contact pins 16 protrude into the electronics compartment 5 in order to make contact with the motor or inverter electronics 18. In the exemplary embodiment, a three-phase stator winding 8 is provided, so that correspondingly three contact pins 16 connected via the connection contacts 15 as contact elements to the coils 13 of the stator or rotating field winding 8 are provided as phase connections for the stator or rotating field winding 8 and are routed to the motor electronics 18 and (electrically) contacted there.

As can be seen in FIG. 2, the annular main body part 9 of the stator main body 7 forms a receiving or mounting space 32, in which the axle bolt 17 oriented in axial direction A is located as the rotation axis D for the rotor 3. In addition, the contact pins 16, which serve as phase connections, are located in this receiving space 32. Furthermore, a radial lug 33, which serves as a feedthrough for the respective contact pin 16, projects into the receiving space 32. This radial lug is formed from some of the laminations 37 of the stator main body 7. An insulating dome or pin 34 projects, preferably form-fittingly, into the radial lug 33 or its through-opening, through which the respective contact pin 16 passes. The insulating dome or insulating pin 34 is preferably part of the coil insulation 12 shown at the bottom in FIGS. 1 and 2 and is therefore preferably molded onto it.

With reference to FIG. 1, at least one further radial lug 35 is also formed by the stator main body 7 of the stator 2 or by its lamination stack and projects into the receiving space 32. The radial lug 35 has a through-opening for the respective fastening element or the fastening bolt 29 and is used with this for mounting the stator 2 on the motor carrier 4, in particular for screw fastening.

The motor carrier 4 has a receiving groove 36 in which the electronics compartment lid 6 sits with its peripheral lid wall 6b. The receiving groove 36 is provided or filled with a potting compound V, so that a reliable seal of the electronics compartment 5 is created. A region of the inner connector part 21, in which the lid wall 6b is seated with a corresponding wall portion, and the plug compartment 20 are also provided or filled with the sealing or potting compound V.

FIG. 3 shows the stator 2 (screw-fastened to the motor carrier 4 by the fastening elements 29) with a view of the upper coil insulation 11. The connection cable 19 connected to the outer plug part 22 can be seen.

Looking also at FIG. 4, the upper coil insulation 11 has a number of functional elements 42 on an inner radius of the receiving or mounting space 32 of the stator 2. These serve to hold and/or position the contact pins 16 in their intended or correct target position on or in relation to the connection contacts 15, in order to be contacted with these at the corresponding contact position, for example by using (laser) welding contacting. Preferably in addition, the functional elements 42 are provided and set up to hold the connection contacts 15 on the coil insulation 11, in particular in their intended position by using a plug-in fastening.

FIG. 4 shows a detail of the stator 2 of the electric motor 1 with its stator main body 7 with the ring-shaped main body part 9 and the stator teeth 10 molded onto the outer side circumferentially and directed outwards in the radial direction R as well as with the coils 13 of the stator winding 8 disposed thereon with the upper coil insulation 11 interposed. The connection contacts 15, three in the exemplary embodiment, and the (phase) contact pins 16 contacted with them as well as the stator main body 7 formed from the laminations 37 stacked to form the laminated core are recognizable. The connection contacts 15 have, preferably flexible, contact lugs (bending lugs) 38, in or on which the winding loops or winding ends 14 are contacted, for example by using laser welding and/or clamp contacting.

The three (phase) contact pins 16 in contact with the connection contacts 15 can be seen when looking into the receiving or mounting space 32. The fastening or radial lugs 35 formed by the stator main body 7 or by the laminations 37 of the laminated stack or laminated core are shown with through-openings 40 for the fastening elements 29 for holding the stator 2 on the motor carrier (on the motor carrier plate) 4. In addition, a bolt receptacle 41 in the motor carrier 4 for the axle bolt 17 is shown.

FIG. 4 also shows the, in particular fork-shaped, holding or positioning elements 42a, in or with which the contact pin 16 is held or fixed in the desired position for contacting the respective connection contact 15. The fork-shaped holding or positioning elements 42a as functional elements 42 are formed on the inner circumference of the upper coil insulation 11 and project in the radial direction R into the receiving or mounting space 32.

FIG. 4 also shows the radial lugs 33 provided on the stator main body 7 or formed from its laminations 37 and projecting inwards in the radial direction R into the receiving or mounting space 32 with the insulating domes or insulating pins 34 seated therein. These are formed on radially inwardly directed (radial) lugs 43 of the lower coil or winding insulation 12. The radial lugs 43 have unspecified through-openings for the associated contact pins 16.

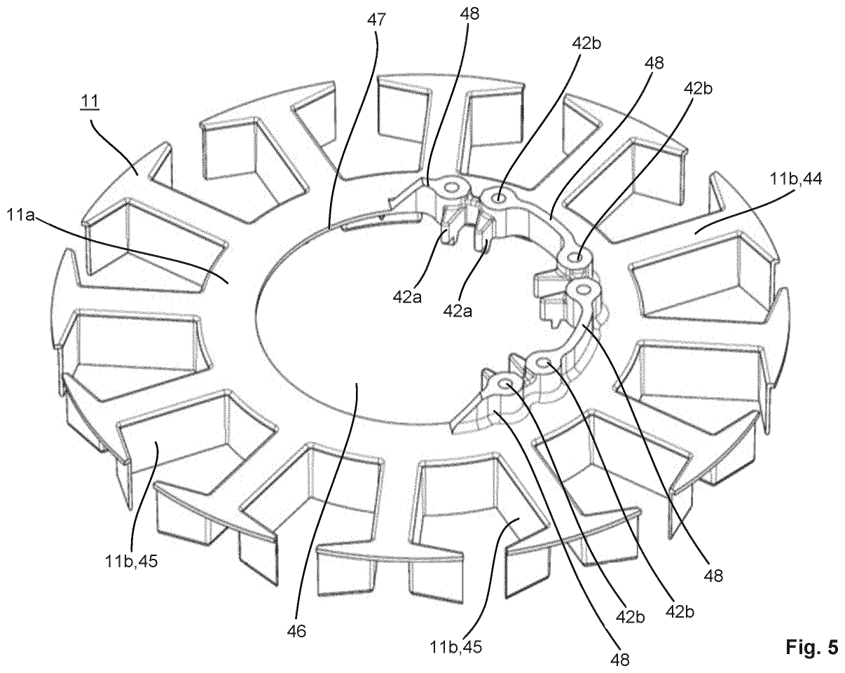

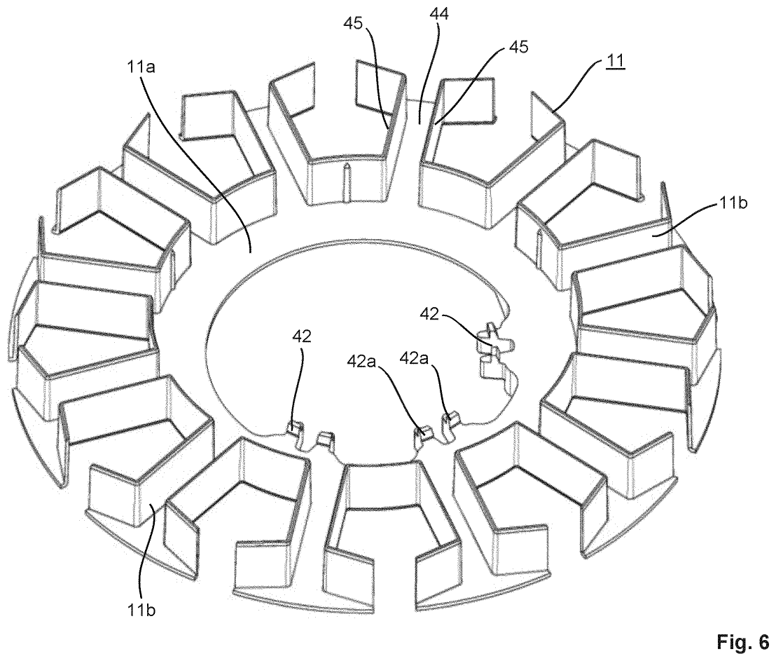

FIGS. 5 and 6 show, in different perspective views, in particular in a plan view or in a bottom or rear view, the upper coil or winding insulation 11 disposed on the side of the stator 2 facing away from the motor carrier 4 on its stator main body 7. This has a ring body 11a as well as tooth caps 11b formed on the (outer) circumferential side and directed radially outwards (in the radial direction R, in a star shape), which cover the stator teeth 10 on the stator side facing away from the motor carrier 4 and at least partially cover their tooth sides or lateral surfaces extending in the axial direction. The tooth caps 11b of the upper coil or winding insulation 11 have a cover cap portion 44 extending in the plane of the ring body 11a and side cap portions 45 formed thereon, which extend radially and are oriented axially or are oriented in the radial direction R and extend in the axial direction A along the side surfaces of the stator teeth 10.

According to FIG. 5, the ring body 11a of the upper coil or winding insulation 11 has axially raised annular walls 48 in the region of an annular edge 47 delimiting its annular opening 46, in particular formed or provided on the inner radius of the receiving or mounting space 32. In the exemplary embodiment, the entirety of the annular walls 48 extends over approximately half the inner circumference of the ring opening 46 of the ring body 11a. Axial plug-in openings 42b are provided on the opposite narrow or end faces of two annular walls 48. Two further annular walls 48, which are outer in the circumferential direction of the ring body 11a, each have only one plug-in opening 42b. In pairs, the plug-in openings 42b form the functional elements 42 for holding the connection contacts 15 on the coil insulation 11. For this purpose, the connection contacts 15 have plug pins 49 corresponding to the plug-in openings 42b, of which only one of the plug pins 49 on one of the connection contacts 15 is marked in FIG. 1 for reasons of clarity.

The functional elements 42 in the form of the fork-shaped holding or positioning elements 42a provided for holding and/or positioning the contact pins 16 in their intended or correct target position at the corresponding contact position to the connection contacts 15 are formed on the annular walls 48 in the region of the paired insertion openings 42b and project in the radial direction R into the mounting space 32 of the stator 2. The functional elements 42, 42a provided for holding and/or positioning the contact pins 16 are configured as radial support pins or support elements, between which the respective contact pin 16 is disposed or received in order to position them in their nominal position for a reliable contact connection with the associated connection contact 16, for example by using laser welding.

In summary, the invention relates to an electric motor 1 including a motor carrier 4 and a stator 2 attached thereto as well as a rotor 3 circulating around it, wherein a coil or winding insulation 11 is provided at least on the side of the stator 2 facing away from the motor carrier 4, wherein contact pins 16, which make contact with the stator winding 8 of the stator 2 via connection contacts 15 and are guided into an electronics compartment 5 on the carrier side, are disposed in a receiving or mounting space 32 of the stator, and wherein the coil or winding insulation 11 has a ring body 11a, on which functional elements 42, 42a, 42b are integrally molded for holding, positioning and/or centering the contact pins 16 and/or the connection contacts 15.

The claimed invention is not limited to the embodiments described above. Rather, other variants of the invention may also be derived therefrom by a person skilled in the art within the scope of the disclosed claims without departing from the subject matter of the claimed invention. In particular, all the individual features described in conjunction with the various exemplary embodiments can also be combined in other ways within the scope of the disclosed claims without departing from the subject matter of the claimed invention.

In addition, the solution described can be used not only in the specific application shown, but also in a similar configuration for other vehicle applications, such as door and tailgate systems, power windows, adjustable seat and interior systems and electric drives.

The following is a summary list of reference numerals and the corresponding structure used in the above description of the invention:
1 electric motor
2 stator
3 rotor
4 motor carrier/carrier plate
5 electronics compartment
6 electronics compartment lid
6a lid base
6b lid wall
7 stator main body
8 stator/rotating field winding
9 main body part
10 stator tooth
11 (upper) coil insulation
11a ring body
11b tooth cap
12 (lower) coil insulation
13 coil
14 winding loop/winding end
15 connection contact
16 contact pin
17 axle bolt
18 motor/converter electronics
19 connection cable
20 plug compartment
21 (inner) plug part
22 (outer) plug part
23 rotor housing
23a housing base
23b housing/annular wall
24 permanent magnet
25 housing portion/bearing housing
26 roller/ball bearings
27 bearing ball
28 mounting element
29 fastening element
30 sealing element
31 through-opening
32 receiving/mounting space
33 radial lug
34 insulating dome/pin
35 radial lug
36 receiving groove
37 lamination
39 winding loop/end
40 through-opening
41 bolt receptacle
42 functional elements
42a positioning/support element
42b plug opening
43 radial lug
44 cover cap portion
45 side cap portions
46 ring opening
47 ring edge
48 annular wall
49 plug pins
A axial direction
D motor/rotation axis
R radial direction
V potting/sealing compound

1. An electric motor or radiator fan motor of a motor vehicle, the electric motor comprising:
a motor carrier having an electronics compartment for accommodating motor electronics;
a stator fastened to said motor carrier, said stator having a stator winding, and said stator having a stator main body with an annular main body part and radially outwardly directed stator teeth, said annular main body part of said stator main body forming a receiving or mounting space;
a rotor circulating around said stator about a rotation axis;
a coil or winding insulation disposed on said stator main body, said coil or winding insulation disposed on a side of said stator facing away from said motor carrier, or said coil or winding insulation disposed on said side of said stator facing away from said motor carrier and on a side of said stator facing said motor carrier;
axially oriented contact pins disposed in said receiving or mounting space and guided into said electronics compartment via through-openings formed in said motor carrier;
connection contacts, said axially oriented contact pins making contact or configured to make contact with said stator winding via said connection contacts;
said coil or winding insulation disposed on said side of said stator facing away from said motor carrier on said stator main body having a ring body and tooth caps being integrally molded on a circumferential side of said ring body, being directed radially outwards and at least partially covering said stator teeth; and
functional elements integrally molded on an inside of said ring body for at least one of holding, positioning or centering at least one of said contact pins or said connection contacts.

2. The electric motor according to claim 1, wherein said functional elements for at least one of holding or positioning said contact pins are fork-shaped, and each of said functional elements have two radial support pins between which a respective contact pin is disposed.

3. The electric motor according to claim 1, wherein said stator winding has winding loops or winding ends and coils, and said ring body has axially raised annular walls with plug-in openings acting as said functional elements for said connection contacts and being configured for contacting said winding loops or winding ends or coils.

4. The electric motor according to claim 3, wherein said functional elements for at least one of holding or positioning said contact pins are integrally molded onto said annular walls.

5. The electric motor according to claim 1, which further comprises sealing elements disposed in said through-openings of said motor carrier, said contact pins being guided into said electronics compartment via said sealing elements.

6. The electric motor according to claim 1, wherein said tooth caps of said coil or winding insulation disposed on a side of said stator facing away from said motor carrier on said stator main body have a cover cap portion extending in a plane of said ring body and side cap portions integrally molded on said cover cap portion.

7. The electric motor according to claim 6, wherein said side cap portions extend radially and are oriented axially.

8. The electric motor according to claim 1, wherein said stator main body is formed as a laminated core formed from a plurality of stacked laminations.

9. The electric motor according to claim 1, wherein said stator main body has radial lugs aligned with said through-openings of said motor carrier, and respective contact pins pass through said radial lugs.

10. The electric motor according to claim 1, wherein said coil or winding insulation disposed on said side of said stator facing said motor carrier on said stator main body has a plurality of axially raised insulating pins corresponding in number to a number of said contact pins, said axially raised insulating pins projecting into said receiving or mounting space of said stator main body and each being penetrated by a respective contact pin.

11. The electric motor according to claim 1, which further comprises fastening elements for fastening said stator to said mounting carrier, said stator main body having radial or fastening lugs projecting into said receiving or mounting space and through-openings for said fastening elements.
